(19) United States
(12) Patent Application Publication
(10) Pub. No.: US 2023/0166711 A1
(43) Pub. Date: Jun. 1, 2023

(54) CONTROLLING ENERGY MANAGEMENT OF A TRACTION BATTERY OF A HYBRID ELECTRIC VEHICLE

(71) Applicant: JAGUAR LAND ROVER LIMITED, Whitley, Coventry, Warwickshire (GB)

(72) Inventors: Matthew HANCOCK, Rugby, Warwickshire (GB); Riccardo FRACCHIA, Coventry, West Midlands (GB)

(21) Appl. No.: 17/920,744

(22) PCT Filed: Apr. 21, 2021
(86) PCT No.: PCT/EP2021/060429

§ 371 Date: Oct. 21, 2022

(30) Foreign Application Priority Data
Apr. 21, 2020 (GB) 2005812.9

(51) Int. Cl. B60W 10/08; B60W 10/26

(52) U.S. Cl. CPC B60W 10/08; B60W 10/26; H01M 2220/20; B60L 2240/642; B60L 2240/647; B60L 2240/26

(57) ABSTRACT

Aspects of the present invention relate to a control system 208 and method for controlling energy management of a traction battery 200 of a hybrid electric vehicle 10, the traction battery 200 configured to power at least one traction motor 212 coupled to an electric-only axle 213 of the vehicle 10 to provide all-wheel drive, the control system 208 comprising one or more electronic controllers 300, the one or more electronic controllers 300 configured to: determine a change of terrain mode and/or type for the vehicle and/or determine an increase in loading of the vehicle 10; select an energy management control strategy for the traction battery 200 of the vehicle 10 in dependence on the determined change in terrain mode and/or type and/or the determined increase in loading of the vehicle 10, wherein the traction battery 200 is configured to supply power to the at least one traction motor 212 to provide torque to the electric-only axle 213 of the vehicle 10 to enable the vehicle 10 to operate in an all-wheel drive mode, wherein selecting an energy management control strategy of the vehicle 10 comprises at least one of: selecting or adjusting a charge sustain set point 30 for the traction battery 200; and changing energy generation to recharge the traction battery 200.

### TECHNICAL FIELD

The present disclosure relates to controlling energy management of a traction battery. In particular, but not exclusively, it relates to controlling energy management of a traction battery of a hybrid electric vehicle.

### BACKGROUND

Hybrid electric vehicles deplete state of charge of one or more traction batteries by driving in electric vehicle mode. Typically, this can continue until a set point is reached in relation to the battery state of charge at which the vehicle enters a different mode of operation in which the state of charge of the traction battery is maintained. In this mode, transient power requirements will sometimes deplete the battery below the set point temporarily. This can result in the state of charge of the traction battery oscillating around the set point due to the transient power requirements.

Thresholds for the battery state of charge can also be implemented to, for example, inhibit all electric vehicle driving and also inhibit all boost and torque fill from a traction motor.

In some driving scenarios particularly high energy usage is required, for example off-road driving.

If energy management of the traction batteries of the vehicle is not carefully controlled there can be insufficient charge to provide required torque from one or more traction motors.

### SUMMARY OF THE INVENTION

It is an aim of the present invention to address one or more of the disadvantages associated with the prior art.

Aspects and embodiments of the invention provide a control system, a system, a vehicle, a method, and computer software, as claimed in the appended claims.

According to an aspect of the invention there is provided a control system for controlling energy management of a traction battery of a hybrid electric vehicle, the traction battery configured to power at least one traction motor coupled to an electric-only axle of the vehicle to provide all-wheel drive, the control system comprising one or more electronic controllers, the one or more electronic controllers configured to: determine a change of terrain mode and/or type for the vehicle and/or determine an increase in loading of the vehicle; select an energy management control strategy for the traction battery of the vehicle in dependence on the determined change in terrain mode and/or type and/or the determined increase in loading of the vehicle, wherein the traction battery is configured to supply power to the at least one traction motor to provide torque to the electric-only axle of the vehicle to enable the vehicle to operate in an all-wheel drive mode, wherein selecting an energy management control strategy of the vehicle comprises at least one of: selecting or adjusting a charge sustain set point for the traction battery; and changing energy generation to recharge the traction battery.

An advantage provided is it can be ensured that all-wheel drive is available in a vehicle where needed. For example, it can be ensured that all-wheel drive is available to a vehicle when needed for off-road driving

The one or more electronic controllers may collectively comprise: at least one electronic processor having an electrical input for receiving information associated with a terrain mode and/or type for the vehicle and/or determining an increase in loading of the vehicle; and at least one electronic memory device electrically coupled to the at least one electronic processor and having instructions stored therein; and wherein the at least one electronic processor is configured to access the at least one memory device and execute the instructions thereon so as to cause the control system to determine a change of terrain mode and/or type for the vehicle and/or determine an increase in loading of the vehicle and to select the energy management control strategy of the vehicle.

Determining a change of terrain type may comprise determining the characteristics and/or type of surface that the vehicle is currently being driven on. Determining a change of terrain mode may comprise receiving at least one input from a user of the vehicle selecting a terrain mode of the vehicle. Determining a change of terrain mode and/or type may comprise receiving information from one or more sensors and processing the received information to determine the current terrain mode and/or type of the vehicle.

Determining an increase in loading of the vehicle may comprise determining that the vehicle is experiencing an increase in drag associated with at least one of: driving over a deformable surface, traversing a water crossing and/or towing. Determining an increase in loading of the vehicle may comprise receiving at least one input from a user of the vehicle indicating an increase in loading of the vehicle. Determining an increase in loading of the vehicle may comprise receiving information from one or more sensors and processing the received information to determine an increase in loading of the vehicle.

Selecting or adjusting a charge sustain set point of the traction battery may comprise increasing the charge sustain set point of the traction battery in dependence on the current terrain type and/or loading of the vehicle.

The charge sustain set point may be selected in dependence on the expected increased power demands from driving in a current terrain mode and/or on a current terrain type and/or with the determined increased loading. The charge sustain set point may be selected in dependence on expected manoeuvres at an expected repetition rate for the current terrain mode and/or type.

Selecting or adjusting a charge sustain set point may comprise setting the charge sustain set point at a prevailing battery charge when the terrain mode and/or type and/or the loading of the vehicle is changed.

Changing energy generation to recharge the traction battery may comprise increasing torque provided by an engine of the vehicle to increase electrical energy generation, to supply electrical energy to the traction battery. Changing energy generation to recharge the traction battery may comprise prioritising discharging the battery to meet driving demands over charging the battery.

Electrical energy generation using the engine of the vehicle may comprise electrical energy generation by a belt integrated starter generator and/or a crank integrated motor generator coupled to the engine.

According to an aspect of the invention there is provided a system comprising the control system and an engine configured to power a first axle, at least one traction motor configured to power a second axle, and a traction battery configured to supply power to the at least one traction motor, wherein the engine is configured to drive a generator to charge the traction battery.

According to an aspect of the invention there is provided a vehicle comprising the control system and/or the system.

According to an aspect of the invention there is provided a method for controlling energy management of a traction battery of a hybrid electric vehicle, the traction battery configured to power at least one traction motor coupled to an electric-only axle of the vehicle to provide all-wheel drive, the method comprising: determining a change of terrain mode and/or type for the vehicle and/or determining an increase in loading of the vehicle; selecting an energy management control strategy for the traction battery of the vehicle in dependence on the determined change in terrain mode and/or type and/or the determined increase in loading of the vehicle, wherein the traction battery is configured to supply power to the at least one traction motor to provide torque to the electric only axle of the vehicle to enable the vehicle to operate in an all-wheel drive mode, wherein selecting an energy management control strategy of the vehicle comprises at least one of: selecting or adjusting a charge sustain set point for the traction battery; and changing energy generation to recharge the traction battery.

Determining a change of terrain mode may comprise receiving at least one input from a user of the vehicle selecting a terrain mode of the vehicle. Determining an increase in loading of the vehicle may comprise determining that the vehicle is experiencing an increase in drag associated with at least one of: driving over a deformable surface, traversing a water crossing and/or towing.

Selecting or adjusting a charge sustain set point of the traction battery may comprise increasing the charge sustain set point of the traction battery in dependence on the current terrain type and/or loading of the vehicle.

The charge sustain set point may be selected in dependence on the expected increased power demands from driving in a current terrain mode and/or on a current terrain type and/or with the determined increased loading.

The charge sustain set point may be selected in dependence on expected manoeuvres at an expected repetition rate for the current terrain mode and/or type. Selecting or adjusting a charge sustain set point may comprise setting the charge sustain set point at a prevailing battery charge when the terrain mode and/or type and/or the loading of the vehicle is changed.

Changing energy generation to recharge the traction battery may comprise increasing torque provided by an engine of the vehicle to increase electrical energy generation, to supply energy to the traction battery.

According to an aspect of the invention there is provided a non-transitory computer readable medium comprising computer readable instructions that, when executed by a processor, cause performance of at least one or more methods described herein.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 illustrates an example of vehicle;

FIG. 2 illustrates an example of a system;

FIGS. 3A, 3B illustrate an example of a control system and of a non-transitory computer readable storage medium;

FIG. 4 illustrates an example of a method;

FIG. 5 illustrates an example of a method;

FIG. 6 illustrates an example of a graph of traction battery state of charge as a function of time; and

FIG. 7 illustrates an example of controlling energy management of a traction battery of a hybrid electric vehicle.

### DETAILED DESCRIPTION

Examples of the present disclosure relate to controlling energy management of a traction battery of a hybrid electric vehicle.

In some examples, the vehicle has at least two axles, a traction battery, a traction motor, an electrical generator/motor/machine and an internal combustion engine. In examples, the electrical generator is powered by the internal combustion engine and is arranged to supply electrical power to the traction battery, which is arranged to store electrical energy and to power the traction motor. Each axle is connected to at least one ground engaging wheel and tyre. In some examples, each axle has a pair of ground engaging wheels and tyres. In examples, one of the axles is powered, at least in part, by torque supplied by the internal combustion engine and one of the axles is powered by torque supplied by the traction motor. The axle powered by torque supplied by the traction motor is thus an electric-only powered axle. The vehicle may be driven by torque supplied by the internal combustion engine alone in a single-axle drive configuration. Additionally, or alternatively, the vehicle may be driven by one axle powered by the internal combustion engine and one axle powered by the traction motor in a two-axle configuration.

In examples, the traction battery is configured to power at least one traction motor coupled to an electric-only axle of the vehicle to provide all-wheel drive. Accordingly, in examples, controlling energy management of a traction battery of a hybrid electric vehicle can be considered controlling availability of all-wheel drive in the hybrid electric vehicle.

Controlling energy management of a traction battery of a hybrid electric vehicle as described herein is advantageous as, for example, it can ensure that all-wheel drive is available in a vehicle where needed. For example, it can ensure all-wheel drive is available to a vehicle when needed for off-road driving or driving on slippery and/or deformable surfaces.

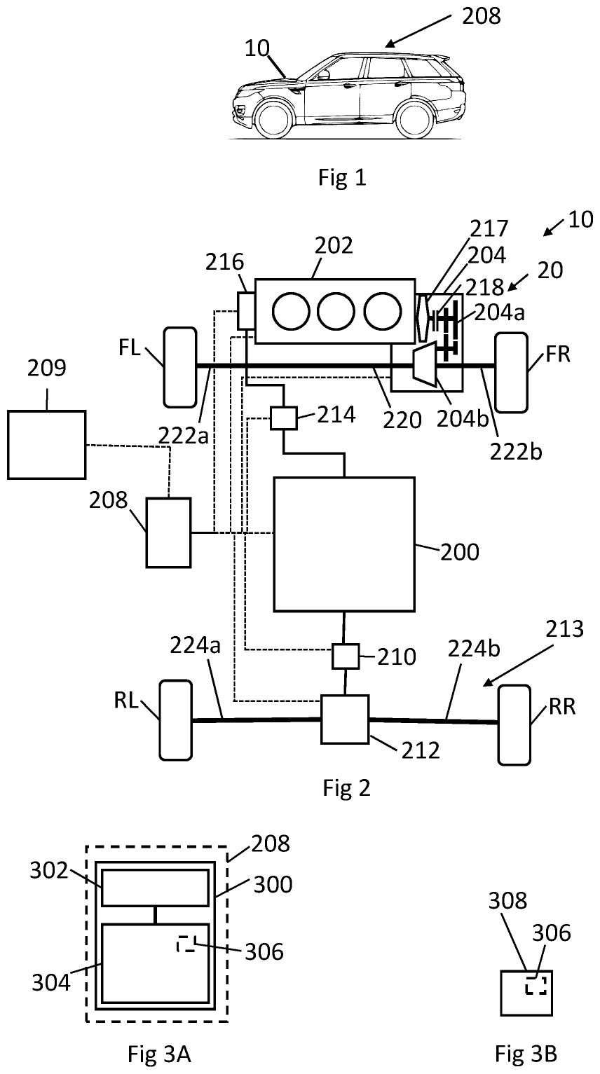

FIG. 1 illustrates an example of a vehicle 10 in which embodiments of the invention can be implemented. In some, but not necessarily all examples, the vehicle 10 is a passenger vehicle, also referred to as a passenger car or as an automobile. In other examples, embodiments of the invention can be implemented for other applications, such as industrial vehicles.

The vehicle 10 is a hybrid electric vehicle (HEV). If the vehicle 10 is an HEV, the vehicle 10 may be a full HEV or a mild HEV. Mild HEVs do not have an electric-only mode of propulsion, but an electric traction motor may be configured to provide torque assistance. Full HEVs have an electric-only mode of propulsion.

If the vehicle 10 is an HEV, the vehicle 10 may be configured to operate as a parallel HEV. Parallel HEVs comprise a torque path between the engine and at least one vehicle wheel, as well as a torque path between an electric traction motor and at least one vehicle wheel. The torque path(s) may be disconnectable by a torque path connector such as a clutch or transmission. Typically, parallel HEVs differ from series HEVs, because in series HEVs the purpose of the engine is to generate electrical energy and there is no torque path between the engine and vehicle wheels.

In the example of FIG. 1, the vehicle 10 comprises a control system 208. The control system 208 is configured to operate as described herein. Accordingly, FIG. 1 illustrates a vehicle 10 comprising a control system 208 as described herein.

FIG. 2 illustrates an example system 20 for an HEV 10. The system 20 defines, at least in part, a powertrain of the HEV. The system 20 comprises a control system 208. The control system 208 comprises one or more controllers. The control system 208 may comprise one or more of: a hybrid powertrain control module; an engine control unit; a transmission control unit; a traction battery management system; and/or the like.

In examples, the control system 208 provides means to control operation, at least in part, directly or indirectly, of the elements illustrated in FIG. 2.

The system 20 comprises at least two torque sources. A torque source refers to a prime mover, such as an engine, an electric machine, or the like. An electric machine is also referred to herein as an electric traction motor or traction motor. The illustrated system 20 comprises an engine 202. The engine 202 is an internal combustion engine (ICE). The illustrated engine 202 comprises three combustion chambers, however a different number of combustion chambers may be provided in other examples.

The engine 202 is operably coupled to the control system 208 to enable the control system 208 to control output torque of the engine 202. The output torque of the engine 202 may be controlled by controlling one or more of: air-fuel ratio; spark timing; poppet valve lift; poppet valve timing; throttle opening position; fuel pressure; turbocharger boost pressure; and/or the like, depending on the type of engine 202.

The system 20 comprises a transmission 204 for receiving output torque from the engine 202. The transmission 204 may comprise an automatic vehicle transmission, a manual vehicle transmission, or a semi-automatic vehicle transmission. The transmission 204 may comprise one or more friction clutches 218 and/or a torque converter 217 between the engine 202 and a gear train 204a. The gear train 204a is configured to provide a selected gear reduction in accordance with a selected gear of the vehicle 10. The gear train 204a may comprise five or more different selectable gear reductions. The gear train 204a may comprise at least one reverse gear and a neutral gear.

The system 20 may comprise a differential 204b which is a second gear train for receiving output torque from the gear train 204a. The differential 204b may be integrated into the transmission 204 as a transaxle, or provided separately.

The engine 202 is mechanically connected (coupled) or connectable (couplable) to a first set of vehicle wheels (FL, FR) via a torque path 220. The torque path 220 extends from an output of the engine 202 to the transmission 204, then and then to first set of vehicle wheels (FL, FR) via a first axle or axles 222a, 222b. In a vehicle overrun and/or friction braking situation, torque may flow from the first set of vehicle wheels (FL, FR) to the engine 202. Torque flow towards the first set of vehicle wheels (FL, FR) is positive torque, and torque flow from the first set of vehicle wheels (FL, FR) is negative torque.

The illustrated first set of vehicle wheels (FL, FR) comprises front wheels, and the axles 222a, 222b are front transverse axles. Therefore, the system 20 is configured for front wheel drive by the engine 202. In another example, the first set of vehicle wheels comprises rear wheels (RL, RR). The illustrated first set of vehicle wheels (FL, FR) is a pair of vehicle wheels, however a different number of vehicle wheels and axles could be provided in other examples.

As illustrated in FIG. 2, axles 222a, 222b linking the first set of wheels FL, FR, together form a front axle assembly of the vehicle 10.

In the illustrated system 20, no longitudinal (centre) driveshaft is provided, to make room for hybrid vehicle components. Therefore, the engine 202 is not connectable to a second set of rear wheels (rear wheels RL, RR in the illustration). The engine 202 may be transverse mounted to save space. In some examples, the engine 202 is configured to drive the rear wheels but not the front wheels.

A torque path connector 218 such as a clutch may be provided inside and/or outside a bell housing of the transmission 204. The clutch 218 is configured to connect and configured to disconnect the torque path 220 between the engine 202 and the first set of vehicle wheels (FL, FR). The system 20 may be configured to automatically actuate the clutch 218 without user intervention.

The system 20 comprises a first electric motor 216. The first electric motor 216 may be an alternating current induction motor or a permanent magnet motor, or another type of motor. The first electric motor 216 is located to the engine side of the clutch 218.

The first electric motor 216 may be mechanically connected (coupled) or connectable (couplable) to the engine 202 via a belt or chain. In examples, the first electric motor 216 is a belt integrated starter generator. The first electric motor 216 and the engine 202 together form a torque source for the first set of vehicle wheels (FL, FR). In the illustration, the first electric motor 216 is located at an accessory drive end of the engine 202, opposite a vehicle transmission end of the engine 202. In an alternative example, the first electric motor 216 is a crankshaft integrated motor generator (also known as a crank integrated starter generator), located at a vehicle transmission end of the engine 202.

The first electric motor 216 is configured to apply positive torque and configured to apply negative torque to a crankshaft (not shown) of the engine 202, for example to provide functions such as: boosting output torque of the engine 202; facilitating the deactivation (shutting off) of the engine 202 while at a stop or coasting; activating (starting) the engine 202; and/or regenerative braking in a regeneration mode. In a hybrid electric vehicle mode, the engine 202 and first electric motor 216 may both be operable to supply positive torque simultaneously to boost output torque. The first electric motor 216 may be incapable of sustained electric-only driving. In an alternative example, the first electric motor 216 is not controllable to provide positive torque other than to start the engine 202. In an alternative example, the first electric motor 216 is a crankshaft integrated motor generator, located at a vehicle transmission end of the engine 202.

When the torque path 220 between the engine 202 and the first set of vehicle wheels (FL, FR) is disconnected, the torque path 220 between the first electric motor 216 and the first set of vehicle wheels (FL, FR) is also disconnected.

FIG. 2 illustrates a second electric motor 212, which can be considered an electric traction motor 212, configured to enable at least an electric vehicle mode comprising electric-only driving. Another term for the second electric traction motor 212 is an electric drive unit 212 or traction motor 212. In some, but not necessarily all examples, a nominal maximum torque of the second electric traction motor 212 is greater than a nominal maximum torque of the first electric motor 216.

Even if the torque path 220 between the engine 202 and the first set of vehicle wheels (FL, FR) is disconnected, the vehicle 10 can be driven in electric vehicle mode because the second electric traction motor 212 is mechanically connected to at least one vehicle wheel.

The illustrated second electric traction motor 212 is configured to provide torque to the illustrated second set of vehicle wheels (RL, RR). The second set of vehicle wheels (RL, RR) comprises vehicle wheels not from the first set of vehicle wheels (FL, FR). The illustrated second set of vehicle wheels (RL, RR) comprises rear wheels, and the second electric traction motor 212 is operable to provide torque to the rear wheels RL, RR via a second, rear transverse axle or axles 224a, 224b. Therefore, the illustrated vehicle 10 is rear wheel driven in electric vehicle mode. In an alternative example, the second set of vehicle wheels comprises at least one vehicle wheel of the first set of vehicle wheels. In a further alternative implementation, the second electric traction motor 212 is replaced with two electric traction motors, one for each rear vehicle wheel RL, RR.

The control system 208 may be configured to disconnect the torque path 220 between the engine 202 and the first set of vehicle wheels (FL, FR) in electric vehicle mode, to reduce parasitic pumping energy losses. For example, the clutch 218 may be opened. In the example of FIG. 2, this means that the first electric motor 216 will also be disconnected from the first set of vehicle wheels (FL, FR).

Another benefit of the second electric traction motor 212 is that the second electric traction motor 212 may also be configured to be operable in a hybrid electric vehicle mode, to enable multi-axle drive (e.g. all-wheel drive) operation despite the absence of a centre driveshaft.

In order to store electrical power for the electric traction motors, the system 20 comprises an electrical energy storage means such as a traction battery 200. The traction battery 200 provides a nominal voltage required by electrical power users such as the electric traction motors.

The traction battery 200 may be a high voltage battery. High voltage traction batteries provide nominal voltages in the hundreds of volts. The traction battery 200 may have a voltage and capacity to support electric only driving for sustained distances. The traction battery 200 may have a capacity of several kilowatt-hours, to maximise range. The capacity may be in the tens of kilowatt-hours, or even over a hundred kilowatt-hours.

Although the traction battery 200 is illustrated as one entity, the function of the traction battery 200 could be implemented using a plurality of small traction batteries in different locations on the vehicle 10.

The first electric motor 216 and second electric traction motor 212 may be configured to receive electrical energy from the same traction battery 200 as shown. The electrical coupling of the first electric motor 216 and the second electric traction motor 212 to a same traction battery 200 enables the vehicle 10 to operate in both parallel and series HEV modes. In series HEV mode, the first electric motor 216 is configured to generate electrical energy from the engine 202 while the torque path 220 is disconnected. The electrical energy is provided to the second electric traction motor 212. In parallel HEV mode, the engine 202 drives the first set of wheels FL, FR and the second electric traction motor 212 drives the second set of wheels RL, RR.

The illustrated system 20 comprises inverters. Two inverters 210, 214 are shown, one for each electric traction motor. In other examples, one inverter or more than two inverters could be provided.

The control system 208 may be configured to determine a change of terrain mode and/or type for the vehicle 10 and/or determine an increase in loading of the vehicle 10.

As used herein, loading of the vehicle can be understood to mean the load experienced by the vehicle 10 when the vehicle 10 is driving. In examples loading of the vehicle can result from environmental factors, such as driving over a deformable surface or through water and/or weight factors such as when the vehicle is towing a trailer or another vehicle. Such an increase in the loading of the vehicle generally results in a requirement for more power to be sent to the wheels in order to maintain vehicle speed.

In examples an increase in loading of the vehicle 10 can increase the drag experienced by the vehicle 10 when driving, resulting in a general increase in requirement for all-wheel drive and/or increased specific requirement for all-wheel drive resulting from the terrain or surface being driven on.

The control system 208 may be configured to select an energy management control strategy for the traction battery 200 of the vehicle 10 in dependence on the determined change in terrain mode and/or type and/or the determined increase in loading of the vehicle 10.

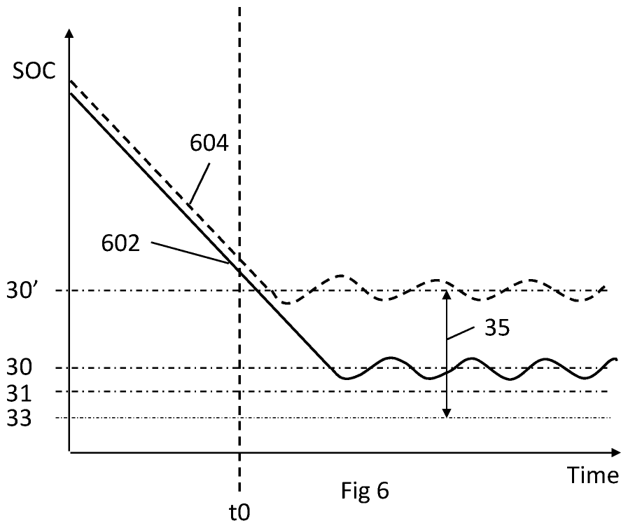

In examples, selecting an energy management control strategy of the vehicle comprises at least on of: selecting or adjusting a charge sustain set point 30 for the traction battery 200; and changing energy/power generation to recharge the traction battery 200. See, for example, FIG. 6.

Accordingly, FIG. 2 illustrates a control system 208 for controlling energy management of a traction battery 200 of a hybrid electric vehicle 10, the traction battery 200 configured to power at least one traction motor 212 coupled to an electric-only axle 213 of the vehicle 10 to provide all-wheel drive, the control system 208 comprising one or more electronic controller 300, the one or more electronic controller configured to:

determine a change of terrain mode and/or type for the vehicle 10 and/or determine an increase in loading of the vehicle 10;
select an energy management control strategy for the traction battery 200 of the vehicle 10 in dependence on the determined change in terrain mode and/or type and/or the determined increase in loading of the vehicle 10, wherein the traction battery 200 is configured to supply power to the at least one traction motor 212 to provide torque to the electric-only axle 213 of the vehicle 10 to enable the vehicle 10 to operate in an all-wheel drive mode, wherein selecting an energy management control strategy of the vehicle 10 comprises at least one of: selecting or adjusting a charge sustain set point 30 for the traction battery 200; and changing energy generation to recharge the traction battery 200.

In examples changing energy generation to recharge the traction battery 200 can comprise or be changing electrical power generation.

FIG. 2 also illustrates a system 20 comprising a control system 208 as described herein and an engine 202 configured to power a first axle, at least one traction motor 212 configured to power a second axle, and a traction battery 200 configured to supply power to the at least one traction motor 212, wherein the engine 202 is configured to drive a generator to charge the traction battery 200.

In the example of FIG. 2, the system 20 comprises further systems 209. In examples, the further system 209 can be considered one or more vehicle systems 209 or one more further vehicle systems 209.

In examples, the one or more vehicle systems 209 are any suitable vehicle system(s) 209 of the vehicle 10. For example, the one or more vehicle systems 209 may comprise any suitable vehicle system 209 of the vehicle 10 controllable, at least in part, directly or indirectly by the control system 208.

Additionally, or alternatively, the one or more vehicle systems 209 may comprise any suitable vehicle system(s) 209 of the vehicle 10 from which the control system 208 can receive one or more signals, for example, one or more signals comprising information.

In some examples, the one or more vehicle systems 209 may be considered to be further vehicle system(s) 209 separate from, but controlled at least in part by, the control system 2019. For example, the one or more vehicle system 209 can comprise one or more user interfaces and/or one or more transceivers via which user input can be received. Any suitable user interfaces can be used. Any suitable transceivers and/or transmitter(s) and/or receiver(s) can be used.

In some examples, the one or more vehicle systems 209 comprise one or more sensors. For example, one or more sensors configured to provide information to the control system 208 to allow a determination of the characteristics and/or type of surface that the vehicle 10 is currently being driven on.

FIG. 2 also illustrates a vehicle 10 comprising the control system 208 as described herein and/or the system 20 as described herein.

The system 20 of FIG. 2 may comprise any number of additional elements not illustrated in the example of FIG. 2. Additionally, or alternatively, one or more elements of the system 20 illustrated in the example of FIG. 2 may be integrated and/or combined. In an alternative implementation(s), the vehicle 10 may be other than shown in FIG. 2. In some examples, the vehicle 10 may be arranged such that the front wheels FL, FR are driven by one or more traction motors and the internal combustion engine is arranged to send torque to the rear axle via the transmission, such that the rear wheels RL, RR are driven, at least in part, by the internal combustion engine.

In some examples, one or more of the elements illustrated in the example of FIG. 2 may be omitted from the system 20.

FIG. 3A illustrates how the control system 208 may be implemented. The control system 208 of FIG. 3A illustrates a controller 300. In other examples, the control system 208 may comprise a plurality of controllers 300 on-board and/or off-board the vehicle 10.

In examples any suitable control system 208 can be used.

The controller 300 of FIG. 3A includes at least one processor 302; and at least one memory device 304 electrically coupled to the electronic processor 302 and having instructions 306 (e.g. a computer program) stored therein, the at least one memory device 304 and the instructions 306 configured to, with the at least one processor 302, cause any one or more of the methods described herein to be performed.

FIG. 3A therefore illustrates a control system 208, wherein the one or more electronic controllers 300 collectively comprise: at least one electronic processor (302) having an electrical input for receiving information associated with a terrain mode and/or type for the vehicle and/or determining an increase in loading of the vehicle; and at least one electronic memory device (304) electrically coupled to the at least one electronic processor (302) and having instructions (306) stored therein; and wherein the at least one electronic processor (302) is configured to access the at least one memory device (304) and execute the instructions thereon so as to cause the control system (208) to determine a change of terrain mode and/or type for the vehicle and/or determine an increase in loading of the vehicle and to select the energy management control strategy of the vehicle 10.

FIG. 3B illustrates a non-transitory computer-readable storage medium 308 comprising the instructions 306 (computer software).

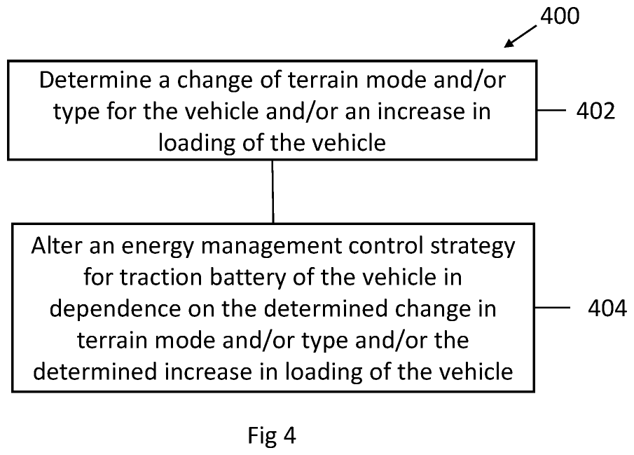

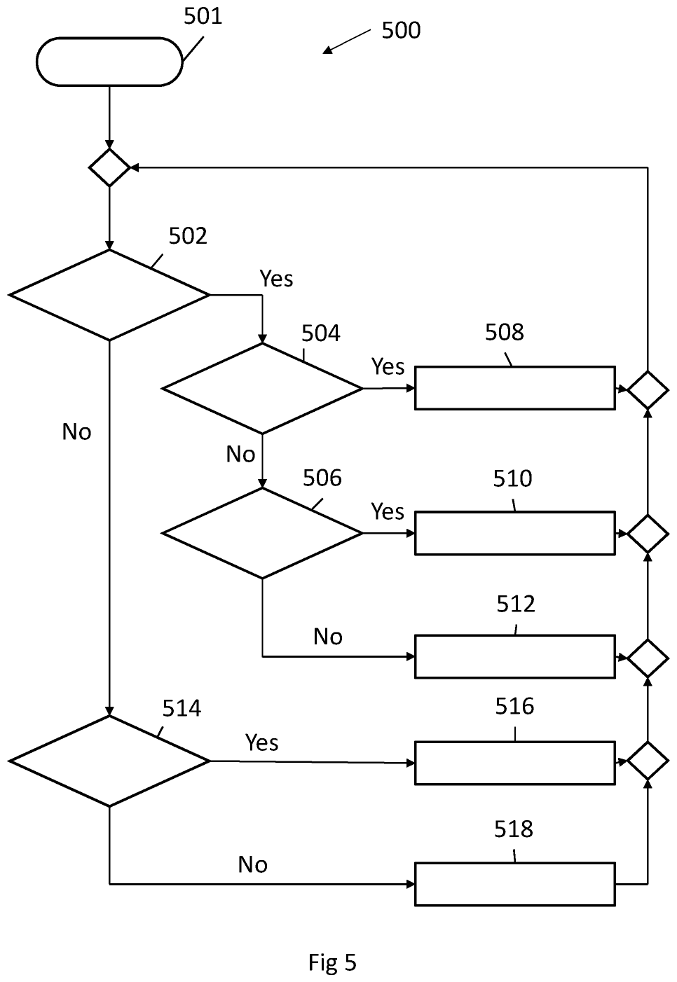

Accordingly, FIG. 3B illustrates a non-transitory computer readable medium 308 comprising computer readable instructions 306 that, when executed by a processor (302), cause performance of at least the method of one or more of FIGS. 4 and 5 and/or as described herein.

FIG. 4 illustrates an example of a method 400.

The method 400 is for controlling energy management of a traction battery 200 of a hybrid electric vehicle 10, the traction battery 200 configured to power at least one traction motor 212 coupled to an electric-only axle 213 of the vehicle 10 to provide all-wheel drive.

In examples, the method 400 is performed by the control system 208 of FIGS. 2 and/or 3A, 3B or a system 20 of FIG. 2.

That is, in examples, the control system 208 described herein comprises means for performing the method 400. However, any suitable means may be used to perform the method 400.

In examples, the method 400 can be considered a computer implemented method 400 for a vehicle 10, the method 400 comprising at least: determining a change of terrain mode and/or type for the vehicle 10 and/or determining an increase in loading of the vehicle 10; selecting an energy management control strategy for the traction battery 200 of the vehicle 10 in dependence on the determined change in terrain mode and/or type and/or the determined increase in loading of the vehicle 10, wherein the traction battery 200 is configured to supply power to the at least one traction motor 212 to provide torque to the electric-only axle 213 of the vehicle 10 to enable the vehicle 10 to operate in an all-wheel drive mode, wherein selecting an energy management control strategy of the vehicle 10 comprises at least one of: selecting or adjusting a charge sustain set point 30 for the traction battery 200; and changing energy generation to recharge the traction battery 200.

At block 402, the method 400 comprises determining change of terrain mode and/or type for the vehicle 10 and/or determining an increase in loading of the vehicle 10.

Terrain modes can include one or more of: general, normal, comfort, grass/gravel/snow (GGS), winter, rain/ice/snow, mud/ruts (MR), sand (SAND), rock crawl and wading or fording modes, and so on.

Terrain types can include one or more of: tarmacadam, concrete, asphalt, paved, gravel of various grade mixture and compaction, snow, ice, sand, grass, rocks, boulders, earth, mud, water of various depths and so on.

Any suitable method for determining a change of terrain mode and/or type for the vehicle 10 and/or determining an increase in loading of the vehicle 10 can be used.

In examples a terrain mode is an operating mode of the vehicle 10. A vehicle operating mode may be selectable manually, semi-automatically, or automatically.

A change in terrain mode/operating mode of the vehicle can affect and/or change and/or alter one or more settings and/or characteristics of one or more elements of the vehicle 10. For example, a change in terrain mode/operating mode can affect and/or change and/or alter one or more elements of the system 20 illustrated in the example of FIG. 2.

In examples a change in terrain mode/operating mode can affect a plurality of different systems of the vehicle 10 to change, alter and/or affect the set-up of the vehicle 10.

In examples, determining a change of terrain type comprises determining the characteristics and/or type of surface that the vehicle 10 is currently being driven on.

Determining the characteristics and/or type of surface that the vehicle 10 is currently being driven on can be done using any suitable method. In examples, determining characteristics and/or type of surface that the vehicle 10 is currently being driven on comprises monitoring any of the following vehicle parameters: wheel slip; wheel articulation; ride height; road roughness; tyre drag (for example rotational drag of a tyre in contact with the prevailing surface over which the vehicle 10 is travelling); vehicle speed; vehicle acceleration in any of longitudinal, lateral and/or vertical directions; pitch, roll and/or yaw of the vehicle, which may be measured as an angle and/or angular rate; current gear selection; steering angle; steering rate; and/or a measured difference in rotational speeds between the front and rear tyres.

For example, the characteristics and/or type of surface that the vehicle 10 is currently being driven on can be determined by receiving and/or processing one or more signals comprising information.

In examples, signals can be received from one or more sensors to enable a determination of the characteristics and/or type of the surface that the vehicle 10 is currently being driven on. See, for example, FIG. 2.

For example, the prevailing surface that the vehicle 10 is being driven on may be determined, at least in part, by vehicle sensors arranged to monitor the area surrounding the vehicle. In examples, the surface and terrain ahead of the vehicle 10 can be characterized by means of radar and/or lidar signatures and/or camera-based technologies that make use of computer learning algorithms to associate certain visual characteristics of the scene ahead of the vehicle with subsequent vehicle behaviour.

Characteristics of the surface that the vehicle 10 is being driven on can include one or more of: surface friction, surface roughness such as undulations, surface texture such as ruts, holes, deformability which will affect wheel drag, changes in gradient, step changes in height, changes in pitch within the spacing between vehicle axles and so on.

In some examples, determining a change of terrain mode comprises receiving at least one input from a user of the vehicle 10 selecting a terrain mode of the vehicle 10. Any suitable method for receiving at least one input from a user of the vehicle selecting a terrain mode of the vehicle 10 can be used.

In examples, the user can make one or more inputs using any suitable user interface, such as one or more user interfaces of the one or more vehicle systems 209 of FIG. 2.

For example, a user may use one or more user interfaces of FIG. 2 to select a terrain mode of the vehicle 10.

Additionally, or alternatively a user can make one or more inputs via a personal device of the user, such as a mobile phone, computer and so on.

In some examples, determining a change of terrain mode and/or type comprises receiving information from one or more sensors and processing the received information to determine a current terrain mode and/or type of the vehicle 10.

For example, the one or more sensors of FIG. 2 can be configured to provide one or more signals comprising information to the control system 208 to enable the control system 208 to determine the current terrain mode and/or type of vehicle.

Any suitable method for determining an increase in loading of the vehicle 10 can be used.

In examples, determining an increase in loading of the vehicle 10 can comprise determining that the vehicle 10 is experiencing an increase in drag associated with at least one of: driving over a deformable surface, traversing a water crossing and/or towing.

In such examples, a deformable surface can be any deformable surface that the vehicle 10 may drive over resulting in an increase in drag, for example, sand, gravel, snow, mud and so on.

In some examples, determining an increase in loading of the vehicle 10 comprises receiving at least one input from a user of the vehicle 10 indicating an increase in loading of the vehicle 10.

Any suitable method for receiving at least one input from a user of the vehicle indicating an increase in loading of the vehicle 10 can be used.

In examples, the user can make one or more inputs using any suitable user interface, such as one or more user interfaces of the one or more vehicle systems 209 of FIG. 2.

For example, a user may use one or more user interfaces of FIG. 2 to indicate an increase in loading of the vehicle 10.

Additionally, or alternatively a user can make one or more inputs via a personal device of the user, such as a mobile phone, computer and so on.

In some examples, determining an increase in loading of the vehicle 10 comprises receiving information from one or more sensors and processing the received information to determine an increase in loading of the vehicle 10.

For example, the one or more sensors of FIG. 2 can be configured to provide one or more signals comprising information to the control system 208 to enable the control system 208 to determine an increase in loading of the vehicle 10.

At block 404 the method 400 comprises selecting an energy management control strategy for the traction battery 200 of the vehicle 10 in dependence on the determined change in terrain mode and/or type and/or the determined increase in loading of the vehicle 10, wherein the traction battery 200 is configured to supply power to the at least one traction motor 212 to provide torque to the electric-only axle 213 of the vehicle 10 to enable the vehicle 10 to operate in an all-wheel drive mode. In examples, selecting an energy management control strategy for the traction battery 200 of the vehicle 10 can be considered and/or can comprise altering and/or controlling an energy management control strategy for the traction battery 200 of the vehicle 10 in dependence on the determined change in terrain mode and/or type and/or the determined increase in loading of the vehicle 10.

In examples, selecting an energy management control strategy of the vehicle comprises at least one of: selecting or adjusting a charge sustain set point 30 for the traction battery 200; and changing energy generation to recharge the traction battery 200. In examples selecting or adjusting a charge sustain set point 30 for the traction battery 200 can be considered and/or can comprise changing a charge sustain set point 30 for the traction battery 200.

In examples a charge sustain set point can be considered a pre-determined or variable level of the traction battery state of charge, which the control system 208 uses as a target around which the traction battery state of charge can vary and to which it tends.

Any suitable method for selecting an energy management control strategy for the traction battery 200 of the vehicle 10 in dependence on the determined change in terrain mode and/or type and/or the determined increase in loading of the vehicle 10 can be used.

In some examples, selecting or adjusting a charge sustain set point 30 of the traction battery 200 comprises increasing the charge sustain set point 30 of the traction battery 200 in dependence on the current terrain type and/or loading of the vehicle 10.

For example, the charge sustain set point 30 can be increased in dependence on expected increased requirement for all-wheel drive due to the current terrain mode and/or type and/or loading of the vehicle 10.

In some examples, the charge sustain set point is selected in dependence on the expected increase in electrical power demands from driving in a current terrain mode and/or on a current terrain type and/or with the determined increased loading.

For example, the charge sustain set point can be selected in dependence on the expected requirement for provision of all-wheel drive in a current terrain mode and/or on a current terrain type and/or due to the loading of the vehicle 10.

In some examples, the charge sustain set point is selected in dependence on expected manoeuvres at an expected repetition rate for the current terrain mode and/or type.

For example, the charge sustain set point 30 can be selected in dependence on an expected requirement of torque to be provided by the traction motor 212 to provide all-wheel drive for the vehicle 10 due to the current terrain mode and/or type.

Any suitable method for determining an expected repetition rate for a terrain mode and/or type can be used. In examples, the driving manoeuvres and cycles that will be needed for a predetermined level of vehicle performance in a particular environment can be determined. This can be determined using computer aided simulation and/or test data and can be expressed as a torque requirement versus time.

For example, a vehicle can be driven on a particular off-road route that represents the most demanding driving that the vehicle will be expected to perform. The wheel torque of an optimally capable system can be measured throughout the route. In examples, differences between the vehicle from which the data was taken and a vehicle that is being designed can be taken account of in one or more simulations.

In examples, selecting or adjusting a charge sustain set point 30 comprises setting the charge sustain set point 30 at a prevailing battery charge when the terrain mode and/or type and/or the loading of the vehicle is changed.

In examples, the charge sustain set point can be changed for any suitable period of time. In some examples, the charge sustain set point 30 can be changed until the terrain mode and/or type has changed and/or the vehicle loading is reduced.

In examples, energy generation to recharge the traction battery 200 can be changed in any suitable way. For example, changing energy generation to recharge the traction battery 200 can comprise changing the amount of electrical energy supplied to and/or from the traction battery 200.

In some examples, energy generation to recharge the traction battery 200 can be increased in dependence on the determined change of terrain mode and/or type of the vehicle and/or determined increased loading of the vehicle 10 in view of expected increase torque demands and/or increased requirement for all-wheel drive from the traction motor 212 of the vehicle 10.

In some examples, changing energy generation to recharge the traction battery 200 comprises increasing torque provided by an engine 202 of the vehicle 10 to increase electrical energy generation, to supply electrical energy/power to the traction battery 200.

In examples, the engine 202 of the system 20 of FIG. 2 is be used to charge the traction battery 200.

In some examples, changing energy generation to recharge the traction battery 200 comprises prioritising discharging the battery 200 to meet driving demands over charging the battery 200.

That is, in some examples discharging the battery 200 can be prioritised in order to ensure that the vehicle 10 can provide all-wheel drive as needed for the vehicle 10 to drive in the current terrain mode and/or negotiate the prevailing surface type and/or drive with the current loading of the vehicle 10.

Electrical energy generation using the engine 202 of the vehicle 10 can be done in any suitable way and using any suitable method.

In some examples, electrical energy generation using the engine 202 of the vehicle 10 comprises electrical energy generation via a belt integrated starter generator (BISG) and/or crank integrated motor generator (CIMG) coupled to the engine 202. See, for example, FIG. 2

A technical effect of the method 400 is that the vehicle 10 is able to provide all-wheel drive as required on different driving surfaces and/or with increased loading by having sufficient state of charge of the traction battery 200 to supply the traction motor 212 so as to provide torque to the electrically driven axle 213.

Additionally, as the vehicle 10 does not change the energy control strategy for all driving modes and/or types and/or vehicle loading the vehicle 10 can still, for example, maximise efficiency benefits from allowing a wider range of battery energy to be used in, for example, normal road driving.

FIG. 5 illustrates an example of a method 500.

The method 500 is for controlling energy management of a traction battery 200 of a hybrid electric vehicle 10, the traction battery 200 configured to power at least one traction motor 212 coupled to an electric-only axle 213 of the vehicle 10 to provide all-wheel drive.

In examples, the method 500 is performed by the control system 208 of FIGS. 2 and/or 3A, 3B or a system 20 of FIG. 2.

The example of FIG. 5 can be considered to illustrate an example of control behaviour of the control system 208.

The method 500 starts at block 501 and proceeds to decision block 502 in which it is determined if the driving mode of the vehicle 10 is set for an off-road surface with potential of high electric traction demands from the traction motor 212.

If the answer is no at block 502, the method proceeds to decision block 514 where it is determined if the traction battery 200 state of charge is above a pre-set minimum chosen for normal driving.

If the answer is yes at block 514, the method proceeds to block 516 in which charge depleting control is used and the method proceeds back to the start.

If the answer at block 514 is no the method proceeds to 518 in which charge sustain control with a target at the predefined minimum for normal driving is used and the method proceeds back to the start.

If the answer at block 502 is yes, the method proceeds to block 504 where it is determined if the traction battery 200 state of charge is below a pre-set minimum chosen to provide enough reserve energy for the determined terrain mode/type.

If the answer at block 504 is yes, the method proceeds to block 508 in which the control system 208 acts to increase the state of charge of the traction battery 200 and the method returns to the start.

In acting to increase the state of charge of the traction battery 200 the control system 208 will, for example, use torque from the engine 202 of the vehicle 10.

If the answer at block 504 is no, the method proceeds to block 506 in which it is determined if there has been a change such that a terrain mode with potential high electric traction demands from the traction motor 212 has been set.

If the answer at block 506 is yes, the method proceeds to block 510 in which charge sustain and control is used and the charge sustain set point is set to the prevailing state of charge of the traction battery 200 and the method returns to the start.

If the answer at block 506 is no the method proceeds to block 512 in which charge sustaining control is used with a charge sustain set point set at a level set when the answer at block 506 was last positive and the control returns to the start.

If there has never been a positive answer at block 506 a pre-set minimum, such as that considered in block 504, can be used as the set point.

FIG. 6 illustrates a graph of traction battery state of charge as a function of time.

In the example of FIG. 6 the solid line 602 illustrates the state of charge of the traction battery 200 without the inventive energy management control for the traction battery 200 described herein.

As can be seen by the solid line 602, the state of charge of the traction battery 200 steadily decreases until the charge sustain set point 30, illustrated by the dot-dashed line, is reached.

After this point, the state of charge of the traction battery 200 oscillates around the charge sustain set point 30 due to varying demands.

However, it can be seen in FIG. 6 that the charge sustain set point 30 is relatively low and, therefore, if the vehicle 10 were to encounter a driving surface, such as sand, requiring increased use of all-wheel drive there would not be sufficient state of charge for the traction battery 200 to provide all-wheel drive as required.

The dashed line 604 in FIG. 6 illustrates the state of charge of the traction battery 200 when using the inventive energy management control for the traction battery 200 as described herein.

In the example of FIG. 6 the charge sustain set point 30 has been selected in dependence on a determined terrain mode and/or type and/or increase in loading of vehicle 10 at time t0, illustrated by the dashed vertical line, and has, in this example, been raised to be set point 30′.

This is illustrated by the upper dot-dashed line 30′ in the example of FIG. 6.

As can be seen by the dashed line 604 the state of charge of the traction battery 200 steadily decreases until the selected charge sustain set point 30′ is reached after which the state of charge of the traction battery 200 is maintained at that level.

Accordingly, the state of charge of the traction battery 200 is higher for completing expected manoeuvres on a surface, such as sand, in which required provision of all-wheel drive is increased.

In the example of FIG. 6 further dot-dashed lines 31, 33 are illustrated below the charge sustain set point 30.

These are thresholds 31, 33 at which further control can be implemented, such as prohibiting electrical-only mode and prohibiting use of the traction motor 212. In examples there can be a threshold at which electric traction in parallel hybrid operation begins to be reduced and a lower threshold by which electric traction in parallel hybrid operation is completely removed.

In the example of FIG. 6, when the inventive energy management control is used, the control system 208 will charge the traction battery 200 if the state of charge of the traction battery 200 is within the region indicated by the double headed arrow 35.

In examples, how the charging occurs can be controlled in dependence on the determined terrain mode and/or type and/or increase in loading of the vehicle 10.

For example, the control system 208 can control the engine 202 of the vehicle 10 to prioritise charging the traction battery 200 on certain terrain types compared to other terrain types where lower priority for charging the traction battery 200 is used.

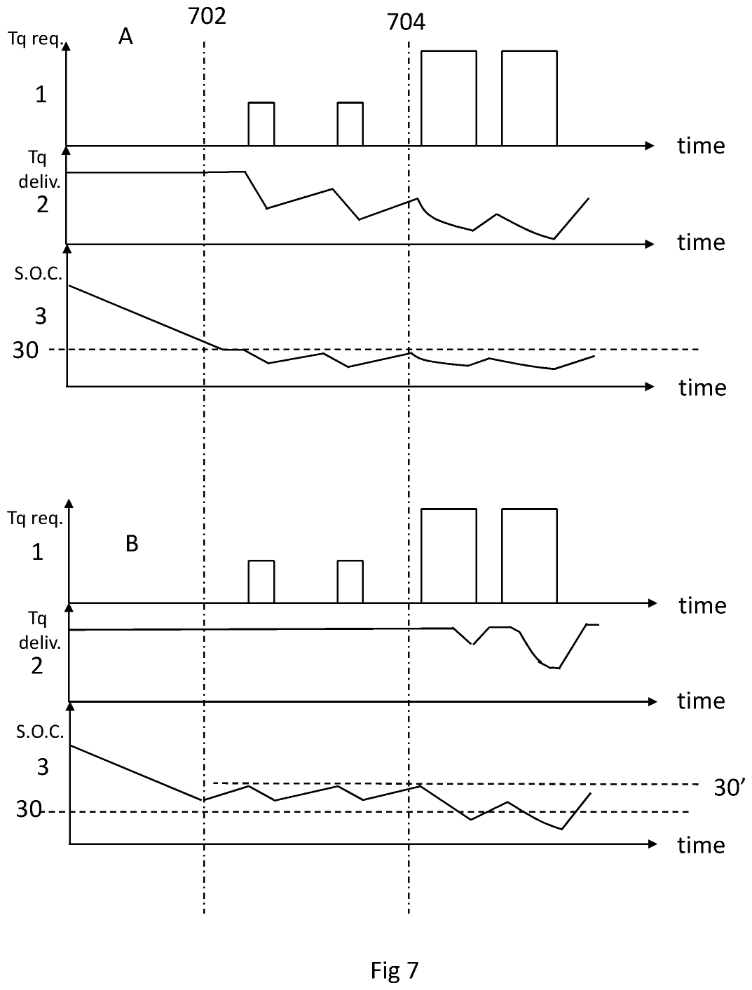

FIG. 7 illustrates an example of controlling energy management of a traction battery 200 of a hybrid electric vehicle 10.

In examples, the hybrid electric vehicle 10 is the vehicle in FIG. 2.

The example of FIG. 7 is split into two sections an upper section A and a lower section B. The upper section of FIG. 7 can therefore be considered FIG. 7A and the lower section of FIG. 7 can be considered FIG. 7B.

The upper section A illustrates behaviour without the inventive control described herein.

In FIG. 7A three graphs are illustrated. The upper panel, graph 1, illustrates a simplified version of electric traction required from the traction motor 212 as a function of time. The electric traction required is shown when particularly high amounts of torque are required compared to normal use.

The middle panel, graph 2, illustrates electric traction deliverable as a function of time and the lower panel, graph 3, illustrates traction battery 200 state of charge as a function of time.

In addition, two specific events at times 702 and 704 are marked in FIG. 7A.

At time 702 the driver of the vehicle selects an off-road surface mode for the vehicle.

In the example of FIG. 7, the most extreme off-road conditions are encountered after the time indicated at 704.

In the first period, before time 702, the vehicle is driving in normal conditions and the control system 208 is allowing the battery state of charge to deplete to the charge sustain set point 30, therefore, in this example, the battery state of charge decreases accordingly while full electric traction is deliverable.

It can be seen in the first panel of FIG. 7A that in between times 702 and 704 moderate electric traction from the traction motor 212 is required in two periods.

In the example of FIG. 7A, when the periods of moderate torque from the traction motor 212 are required the battery state of charge is already relatively low as the charge sustain set point 30 has been reached prior to encountering the first significant increase in traction to be provided by the traction motor 212.

In the middle time period between times 702 and 704 the electric traction power deliverable decreases as the battery state of charge is affected by the increased electric traction requirements.

As the charge sustain set point has been reached, the battery state of charge is increased after encountering the periods where moderate electric traction is required.

After time 704 it can be seen that two longer periods requiring higher levels of electric traction are encountered.

However, in the example of FIG. 7A the battery state of charge is insufficient to deliver the electric traction power required to meet those demands. This can be seen from the low levels of deliverable torque after time 704 in plot 2 of FIG. 7A.

This means that, in this example, the vehicle 10 cannot deliver electric traction as required by the off-road conditions encountered after time 704, causing a reduction in the driving ability of the vehicle 10.

In the example of FIG. 7B, the inventive energy management control described herein is used.

In the example of FIG. 7B the same graphs are illustrated in panels one, two and three and the drive cycle is the same in FIG. 7B as that described in 7A.

However, in the example of FIG. 7B, after time 702, at which the different terrain mode is selected, the vehicle 10 charges the traction battery 200 increasing the state of charge of the traction battery 200 up to the point where the first period where moderate electric traction as required is encountered. In the example of FIG. 7B, a higher charge sustain set point 30′ is used after the different terrain mode is selected at time 702. In this example, the system requests more torque from the engine 202 to facilitate the BISG/CIMG to provide an increase in electrical power to the traction battery 200, increasing the state of charge to the higher charge sustain set point 30′.

This means that, in the example of FIG. 7B, the electric traction deliverable remains constant between times 702 and 704 when the periods requiring moderate electric traction are encountered.

As the state of charge of the traction battery 200 has been managed differently after time 702, when time 704 is encountered in FIG. 7B, and the longer periods of electric traction at higher levels are required, thanks to the requested increase in torque from the engine 202, the BISG/CIMG supplies an increased level of electrical power to the traction battery 200 such that the battery state of charge is sufficient to deliver higher levels of electric traction to allow driving ability of the vehicle 10 to remain unaffected or to be significantly improved compared to the example of FIG. 7A.

As used herein “for” should be considered to also include “configured or arranged to”. For example, “a control system for” should be considered to also include “a control system configured or arranged to”.

For purposes of this disclosure, it is to be understood that the controller(s) described herein can each comprise a control unit or computational device having one or more electronic processors. A vehicle and/or a system thereof may comprise a single control unit or electronic controller or alternatively different functions of the controller(s) may be embodied in, or hosted in, different control units or controllers. A set of instructions could be provided which, when executed, cause said controller(s) or control unit(s) to implement the control techniques described herein (including the described method(s)). The set of instructions may be embedded in one or more electronic processors, or alternatively, the set of instructions could be provided as software to be executed by one or more electronic processor(s). For example, a first controller may be implemented in software run on one or more electronic processors, and one or more other controllers may also be implemented in software run on one or more electronic processors, optionally the same one or more processors as the first controller. It will be appreciated, however, that other arrangements are also useful, and therefore, the present disclosure is not intended to be limited to any particular arrangement. In any event, the set of instructions described above may be embedded in a computer-readable storage medium (e.g., a non-transitory computer-readable storage medium) that may comprise any mechanism for storing information in a form readable by a machine or electronic processors/computational device, including, without limitation: a magnetic storage medium (e.g., floppy diskette); optical storage medium (e.g., CD-ROM); magneto optical storage medium; read only memory (ROM); random access memory (RAM); erasable programmable memory (e.g., EPROM and EEPROM); flash memory; or electrical or other types of medium for storing such information/instructions.

It will be appreciated that various changes and modifications can be made to the present invention without departing from the scope of the present application.

The blocks illustrated in FIGS. 4 and/or 5 may represent steps in a method and/or sections of code in the computer program 306. The illustration of a particular order to the blocks does not necessarily imply that there is a required or preferred order for the blocks and the order and arrangement of the block may be varied. Furthermore, it may be possible for some steps to be omitted.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A control system for controlling energy management of a traction battery of a hybrid electric vehicle, the traction battery configured to power at least one traction motor coupled to an electric-only axle of the vehicle to provide all-wheel drive, the control system comprising one or more electronic controllers, the one or more electronic controllers configured to:
determine a change of terrain mode and/or type for the vehicle and/or determine an increase in loading of the vehicle;
select an energy management control strategy for the traction battery of the vehicle in dependence on the determined change in terrain mode and/or type and/or the determined increase in loading of the vehicle, wherein the traction battery is configured to supply power to the at least one traction motor to provide torque to the electric-only axle of the vehicle to enable the vehicle to operate in an all-wheel drive mode,
wherein selecting an energy management control strategy of the vehicle comprises increasing a charge sustain set point for the traction battery in dependence on the current terrain type and/or loading of the vehicle.

2. The control system of claim 1, wherein determining a change of terrain type comprises determining one or more characteristics and/or type of surface that the vehicle is currently being driven on.

3. The control system of claim 1, wherein determining a change of terrain mode comprises receiving at least one input from a user of the vehicle selecting a terrain mode of the vehicle.

4. The control system of claim 1, wherein determining a change of terrain mode and/or type comprises receiving information from one or more sensors and processing the received information to determine the current terrain mode and/or type of the vehicle.

5. The control system of claim 1, wherein determining an increase in loading of the vehicle comprises determining that the vehicle is experiencing an increase in drag associated with at least one of: driving over a deformable surface, traversing a water crossing and/or towing.

6. The control system of claim 1, wherein determining an increase in loading of the vehicle comprises receiving at least one input from a user of the vehicle indicating an increase in loading of the vehicle.

7. The control system of claim 1, wherein one or more sensors and processing the received information to determine an increase in loading of the vehicle.

8. The control system of claim 1, wherein the charge sustain set point is selected in dependence on expected increased power demands from driving in a current terrain mode and/or on a current terrain type and/or with the determined increased loading.

9. The control system of claim 1, wherein selecting or adjusting a charge sustain set point comprises setting the charge sustain set point at a prevailing battery charge when the terrain mode and/or type and/or the loading of the vehicle is changed.

10. The control system claim 2, wherein the selecting an energy management control strategy of the vehicle comprises changing energy generation to recharge the traction battery, and wherein changing energy generation to recharge the traction battery comprises:
increasing torque provided by an engine of the vehicle to increase electrical energy generation, to supply electrical energy to the traction battery.

11. The control system according to claim 10, wherein electrical energy generation using the engine of the vehicle comprises electrical energy generation by a belt integrated starter generator and/or a crank integrated motor generator coupled to the engine.

12. A system comprising a control system as claimed in claim 1 and an engine configured to power a first axle, at least one traction motor configured to power a second axle, and a traction battery configured to supply power to the at least one traction motor, wherein the engine is configured to drive a generator to charge the traction battery.

13. A vehicle comprising the control system as claimed in claim 1.

14. A method for controlling energy management of a traction battery of a hybrid electric vehicle, the traction battery configured to power at least one traction motor coupled to an electric-only axle of the vehicle to provide all-wheel drive, the method comprising:
determining a change of terrain mode and/or type for the vehicle and/or determining an increase in loading of the vehicle;
selecting an energy management control strategy for the traction battery of the vehicle in dependence on the determined change in terrain mode and/or type and/or the determined increase in loading of the vehicle being indicative of an expected increased power demand, wherein the traction battery is configured to supply power to the at least one traction motor to provide torque to the electric-only axle of the vehicle to enable the vehicle to operate in an all-wheel drive mode,
wherein selecting an energy management control strategy of the vehicle comprises:
increasing a charge sustain set point for the traction battery.

15. A non-transitory computer readable medium comprising computer readable instructions that, when executed by a processor, cause performance of at least the method of claim 14.

16. The control system of claim 1 wherein selecting an energy management control strategy further comprises changing energy generation to recharge the traction battery.

17. The control system of claim 8 wherein the charge sustain set point is selected in dependence on expected manoeuvres at an expected repetition rate for the current terrain mode and/or type.

18. The control system of claim 1, wherein the one or more electronic controllers collectively comprise:
at least one electronic processor having an electrical input for receiving information associated with a terrain mode and/or type for the vehicle and/or determining an increase in loading of the vehicle; and
at least one electronic memory device electrically coupled to the at least one electronic processor and having instructions stored therein;
and wherein the at least one electronic processor is configured to access the at least one memory device and execute the instructions thereon so as to cause the control system to determine a change of terrain mode and/or type for the vehicle and/or determine an increase in loading of the vehicle and to select the energy management control strategy of the vehicle.
